(19) United States
(12) Patent Application Publication
(10) Pub. No.: US 2022/0200773 A1
(43) Pub. Date: Jun. 23, 2022

(54) HANDLING OF TRANSMISSIONS IN THE SERVING CELL DISCOVERY BURST TRANSMISSION (DBT) WINDOW

(71) Applicant: Telefonaktiebolaget LM Ericsson (publ), Stockholm (SE)

(72) Inventors: Peter Alriksson, Hörby (SE); Stephen Grant, Pleasanton, CA (US); Emma Wittenmark, Lund (SE); Havish Koorapaty, Saratoga, CA (US)

(21) Appl. No.: 17/599,879

(22) PCT Filed: Mar. 27, 2020
(86) PCT No.: PCT/EP2020/058825

§ 371 Date: Sep. 29, 2021

Related U.S. Application Data
(60) Provisional application No. 62/826,783, filed on Mar. 29, 2019.

(51) Int. Cl. H04L 5/00

(52) U.S. Cl. CPC H04L 5/0094; H04L 5/0053

(57) ABSTRACT

Methods and systems for handling transmissions in a serving cell Discovery Burst Transmission (DBT) window are provided. According to one aspect, a method performed at a User Equipment (UE) comprises receiving a configuration indicating a serving cell DBT window, receiving a configuration for UE-initiated Uplink (UL) transmission, and suppressing UE-initiated UL transmissions during at least a portion of the serving cell DBT window. These transmissions may be suppressed for the entire serving cell DBT window or suppressed while a base station is transmitting SSBs according to an intended transmit pattern. The suppression may start from a beginning of the serving cell DBT window or from a beginning of a first SSB transmission detected by the UE. The UE may rate match around actual transmitted SSBs that are transmitted within the serving cell DBT window due to various constraints including restrictions on channel access.

### TECHNICAL FIELD

The present disclosure relates to cellular communications networks, and in particular relates to handling of User Equipment (UE) initiated uplink (UL) transmissions during a serving cell Discovery Burst Transmission (DBT) window.

### BACKGROUND

New Radio (NR) defines two types of synchronization signals—the Primary Synchronization Signal (PSS) and the Secondary Synchronization Signal (SSS)—and one broadcast channel—the Physical Broadcast Channel (PBCH). Further, the PSS, SSS, and PBCH are transmitted in one Synchronization Signal (SS)/PBCH block, also called the Synchronization Signal Block (SSB), which may also be referred to as an “SS Block.” One or multiple SSBs can be transmitted within one SS/PBCH burst, and bursts are transmitted periodically. A candidate SS/PBCH block is henceforth also referred to as a “candidate SS/PBCH block position” or a “candidate SSB position.” SSB Beam Sweep. One reason for using multiple SSBs in a burst is when multiple transmissions are needed to cover the intended coverage area, e.g. a cell, e.g. using transmissions in different non-overlapping, or partially overlapping, beams (i.e., beams with different directions). Sequentially transmitting in each of these beam directions is referred to as a beam sweep, e.g. a SS/PBCH block beam sweep.

SS Burst Set. Another reason for using multiple SSBs is when repetitions of the SS/PBCH block transmissions are needed to allow a User Equipment (UE) to accumulate enough energy from multiple SS/PBCH block transmissions (i.e., soft combining) to decode the SS/PBCH block when the UE is located at the edge of the intended coverage area. Such a set of beam swept or repeated SS/PBCH block transmissions is referred to as a SS Burst Set.

FIG. 1 illustrates the general mapping of SSB positions to slots. For a half frame with SSBs, the first symbol indexes for candidate SSBs are determined according to the subcarrier spacing of SSBs as described in Third Generation Partnership Project (3GPP) Technical Specification (TS) 38.213, version 15.2.0. The candidate SSBs in a half frame are indexed in an ascending order in time from 0 to L-1. In FIG. 1, the candidate SSBs are indexed from 0 to 19. A UE determines the two Least Significant Bit (LSB) bits, for L=4, or the three LSB bits, for L>4, of a SS/PBCH block index per half frame from a one-to-one mapping with an index of the Demodulation (DM) Reference Signal (RS) sequence transmitted in the PBCH. In NR Release 15 (Rel-15), eight DM-RS sequences are defined. For L=64, the three Most Significant Bit (MSB) bits of the SS/PBCH block index per half frame used to determine the SS/PBCH block index completely are included in the PBCH payload. In addition, a half frame indicator is present in the PBCH payload.

The UE may assume that SSBs transmitted with the same SS/PBCH block index on the same center frequency location are quasi co-located with respect to Doppler spread, Doppler shift, average gain, average delay, delay spread, and, when applicable, spatial Receive (Rx) parameters. The UE shall not assume quasi co-location for any other SS/PBCH block transmissions.

Not all candidate SSBs have to be transmitted. If the intended coverage area, e.g. a cell, can be covered with fewer SS/PBCH block transmissions, e.g. using wider beamforming, then a smaller number of SSBs can be transmitted than the full number of candidate SSBs L. Any combination of the candidate SSBs may be used. For instance, if there are eight candidate SSBs and only four of them are used for SS/PBCH block transmissions, these four candidate SSBs may be the first four candidate SSBs; the four last candidate SSBs; the first, the second, the fifth, and the sixth candidate SSBs; or any other combination of four candidate SSBs out of the total eight candidate SSBs.

In Release 15 NR the UE is informed which SSBs the NR base station (gNB) transmits using a bitmap in the ssb-PositionslnBurst Information Element (IE). The UE then uses this bitmap to rate match Physical Downlink Shared Channel (PDSCH) around the SSBs and suppress uplink (UL) transmissions in the symbols corresponding to the SSBs.

For Release 16 NR a mechanism to allow the SSBs to shift in time has been agreed. This has so far mainly been motivated by operation in unlicensed spectrum where access to the channel at a precise point in time cannot be guaranteed due to the need to perform a Listen-Before-Talk (LBT) procedure prior to transmitting to determine whether or not the channel is available. Hence the gNB may need to delay transmission of the SSBs until it can gain access to the channel.

Problems with Existing Solutions

There currently exist certain challenge(s). When the SSBs can shift in a window, the current Release 15 mechanisms based on ssb-PositionsInBurst for handling suppression of UE-initiated UL transmissions in symbols colliding with SS/PBCH block(s) are not enough. Specifically, the use of the currently specified positions incurs unnecessary overhead since many more candidate positions than there are actual transmissions need to be set aside for potential SS/PBCH block transmissions. For example, the UE may suppress UE-initiated UL transmissions of an expectation that the gNB will be using the candidate SSB positions during the specified times, but the gNB may be unable to use those candidate SSB positions because it is still performing a LBT process. This means that those candidate SSB positions are being used by neither the gNB nor the UE, i.e. those resources could have been used by the UE but were not.

### SUMMARY

Certain aspects of the present disclosure and their embodiments may provide solutions to the aforementioned or other challenges. Specifically, the present disclosure provides methods and systems for handing of transmissions within a serving cell's Discovery Burst Transmission (DBT) window, (which is also referred to in various standards as a Synchronization Signal Block (SSB) Measurement Timing Configuration (SMTC) window, a Discovery Measurement Timing Configuration (DMTC) window, a Discovery Reference Signal (DRS) transmission window, a Synchronization Signal (SS)/Physical Broadcast Channel (PBCH) block transmission window, and other names). In the present disclosure, these terms are used synonymously.

In a first group of embodiments, a User Equipment (UE) suppresses UE-initiated uplink (UL) transmissions during the entirety of a serving cell DBT window. These UE-initiated UL transmissions can, e.g., be Scheduling Requests (SRs) transmitted on Physical Uplink Control Channel (PUCCH), Physical Random Access Channel (PRACH), or configured grant transmissions.

In a second group of embodiments, the UE only suppresses said transmissions until it has determined that the expected SS/PBCH block(s) have been transmitted by a radio access node. In some embodiments, this radio access node is a New Radio (NR) base station (gNB). While many examples used herein will refer to a gNB, the present disclosure is not limited thereto. That is, after the UE has determined that the gNB has transmitted all SS/PBCH block(s) the gNB intends to transmit, the UE does not suppress the said UL transmissions in the remainder of the transmission window.

Hereinafter, SSBs where the gNB intends to transmit are called candidate SSBs. In this group of embodiments, the UE suppresses UE-initiated transmissions until the last candidate SSB. Note that suppression during a candidate SSB means suppression during symbols where a gNB intends to transmit, regardless of whether the gNB actually transmits during those symbols. In some embodiments, the UE knows where the gNB intends to transmit because the gNB provided that information (i.e., the locations of the candidate SSBs) to the UE.

In a third group of embodiments, the UE uses an existing mechanism for rate matching downlink Physical Downlink Shared Channel (PDSCH) transmissions around SSBs that are being transmitted by the gNB. The existing mechanism is typically used to rate match around reserved resources that may be used for incompatible signals of other technologies. In this group of embodiments, the UE uses this mechanism to rate match around NR signals that are part of the current technology and transmitted from the same cell.

There are, proposed herein, various embodiments which address one or more of the issues disclosed herein.

In some embodiments, a UE method for handling of transmissions in the serving cell DBT window comprises receiving a configuration indicating a serving cell DBT window (and ways of signaling it); receiving configurations for UE-initiated UL transmissions (e.g., PRACH and SRs) as in the prior art; and suppressing UE-initiated UL transmissions in the serving cell DBT window. In some embodiments, the UE-initiated UL transmissions are suppressed during the entire serving cell DBT window. In other embodiments, the UE-initiated UL transmissions are suppressed based on detection of at least one SS/PBCH block transmission by the gNB and information indicating an intended pattern of SS/PBCH block transmissions by the gNB, such as the ssb-PositionslnBurst Information Element (IE).

In some embodiments, when the UE bases suppression on detection of at least one SS/PBCH block and the ssb-PositionslnBurst IE, the UE assumes that the detected SS/PBCH block at position n corresponds to an SS/PBCH block transmitted as if it corresponded to the first bit in ssb-PositionslnBurst set to ‘1’.

In some embodiments, the UE assumes that the last actual transmitted SS/PBCH block occurs at position n+k where k is the index of the last bit position in ssb-PositionslnBurst with bit set to ‘1’. In some embodiments, the UE does not suppress UL transmissions from position n+k+1 to the end of the serving cell DBT window.

In some embodiments, the suppression of transmissions in a slot occurs only in the symbols corresponding to the candidate SS/PBCH block positions.

In some embodiments, the suppression of transmissions in a slot occurs only in the symbols corresponding to the candidate SS/PBCH block positions and the symbols corresponding to the transmission of system information associated with the SS/PBCH block positions.

In some embodiments, the suppression of transmissions occurs in all symbols of a slot which contains a candidate SS/PBCH block position.

Certain embodiments may provide one or more of the following technical advantage(s). The subject matter disclosed herein avoids the UE and gNB competing for access to the channel in the serving cell DBT window and, in the case of the second group of embodiments, prevents the UE unnecessarily suppressing UL transmissions when the gNB has already transmitted the SSBs in the serving cell DBT window.

According to one aspect of the present disclosure, a method, performed at a User Equipment (UE) for handling transmissions in a serving cell DBT window comprises: receiving a configuration indicating a serving cell DBT window; receiving a configuration for UE-initiated Uplink (UL) transmission; and suppressing UE-initiated UL transmissions during at least a portion of the serving cell DBT window.

In some embodiments, receiving the configuration indicating the serving cell DBT window comprises receiving a ServingCellConfigCommon Information Element (IE) or a ServingCellConfigCommonSlB IE containing a field that indicates the duration of the serving cell DBT window.

In some embodiments, the field that indicates the duration of the serving cell DBT window comprises a discoveryBurstWindowLength-r16 field.

In some embodiments, suppressing the UE-initiated UL transmissions during the at least a portion of the serving cell DBT window comprises suppressing UE-initiated UL transmissions during an entire duration of the serving cell DBT window.

In some embodiments, suppressing the UE-initiated UL transmissions during the at least a portion of the serving cell DBT window comprises suppressing UE-initiated UL transmissions during symbols occupied by the SSBs transmitted by the gNB according to the pattern of SSBs.

In some embodiments, receiving the information indicating the pattern of SSBs to be transmitted by the gNB comprises receiving an ssb-PositionslnBurst IE.

In some embodiments, suppressing the UE-initiated UL transmissions during the at least a portion of the serving cell DBT window comprises suppressing UE-initiated UL transmissions until a last SSB to be transmitted by the gNB, including during SSBs during which the gNB does not intend to transmit during that interval.

In some embodiments, suppressing the UE-initiated UL transmissions during the at least a portion of the serving cell DBT window comprises suppressing UE-initiated UL transmissions during all symbols of any slot containing symbols occupied by the SSBs transmitted by the gNB according to the pattern of SSBs.

In some embodiments, suppressing the UE-initiated UL transmissions during the at least a portion of the serving cell DBT window also comprises suppressing symbols corresponding to potential transmissions of system information.

In some embodiments, suppressing the symbols corresponding to the potential transmissions of system information comprises suppressing symbols corresponding to potential transmissions of Remaining System Information (RMSI).

In some embodiments, suppressing the UE-initiated UL transmissions during the at least a portion of the serving cell DBT window comprises suppressing UE-initiated transmissions starting from a beginning of the serving cell DBT window.

In some embodiments, suppressing the UE-initiated UL transmissions during the at least a portion of the serving cell DBT window comprises suppressing UE-initiated UL transmissions starting from a beginning of a first SSB detected.

In some embodiments, the UE presumes that the first SSB detected corresponds to a first SSB in the pattern of SSBs to be transmitted by the gNB.

In some embodiment, the method further comprises using rate matching mechanisms to rate match around reserved resources which may contain signals from other technologies.

In some embodiments, using the rate matching mechanisms comprises using rate matching patterns provided to the UE by the gNB.

According to one aspect of the present disclosure, a UE for handling transmissions in a serving cell DBT window comprises one or more processors and memory comprising instructions that, when executed by the one or more processors, cause the UE to: receive a configuration indicating a serving cell DBT window; receive a configuration for UE-initiated UL transmission; and suppress UE-initiated UL transmissions during at least a portion of the serving cell DBT window.

In some embodiments, receiving the configuration indicating the serving cell DBT window comprises receiving a ServingCellConfigCommon IE or a ServingCellConfigCommonSIB IE containing a field that indicates the duration of the serving cell DBT window.

In some embodiments, the field that indicates the duration of the serving cell DBT window comprises a discoveryBurstWindowLength-r16 field.

In some embodiments, suppressing the UE-initiated UL transmissions during the at least a portion of the serving cell DBT window comprises suppressing UE-initiated UL transmissions during an entire duration of the serving cell DBT window.

In some embodiments, the memory further comprises instructions that, when executed by the one or more processors, cause the UE to receive information indicating a pattern of SSBs to be transmitted by a gNB, and wherein suppressing the UE-initiated UL transmissions during the at least a portion of the serving cell DBT window comprises suppressing UE-initiated UL transmissions during symbols occupied by the SSBs transmitted by the gNB according to the pattern of SSBs.

In some embodiments, receiving the information indicating the pattern of SSBs to be transmitted by the gNB comprises receiving an ssb-PositionslnBurst IE.

In some embodiments, suppressing the UE-initiated UL transmissions during the at least a portion of the serving cell DBT window comprises suppressing UE-initiated UL transmissions until a last SSB to be transmitted by the gNB, including during SSBs during which the gNB does not intend to transmit.

In some embodiments, suppressing the UE-initiated UL transmissions during the at least a portion of the serving cell DBT window comprises suppressing UE-initiated UL transmissions during all symbols of any slot containing symbols occupied by the SSBs transmitted by the gNB according to the pattern of SSBs.

In some embodiments, suppressing the UE-initiated UL transmissions during the at least a portion of the serving cell DBT window also comprises suppressing symbols corresponding to potential transmissions of system information.

In some embodiments, suppressing the symbols corresponding to the potential transmissions of system information comprises suppressing symbols corresponding to potential transmissions of RMSI.

In some embodiments, suppressing the UE-initiated UL transmissions during the at least a portion of the serving cell DBT window comprises suppressing UE-initiated transmissions starting from a beginning of the serving cell DBT window.

In some embodiments, suppressing the UE-initiated UL transmissions during the at least a portion of the serving cell DBT window comprises suppressing UE-initiated UL transmissions starting from a beginning of a first SSB detected.

In some embodiments, the UE presumes that the first SSB detected corresponds to a first SSB in the pattern of SSBs to be transmitted by the gNB.

In some embodiments, the memory further comprises instructions that, when executed by the one or more processors, cause the UE to use rate matching mechanisms to rate match around reserved resources which may contain signals from other technologies.

In some embodiments, using the rate matching mechanisms comprises using rate matching patterns provided to the UE by the gNB.

According to one aspect of the present disclosure, a UE configured to handle transmissions in a serving cell DBT window comprises transceivers and processing circuitry configured to: receive a configuration indicating a serving cell DBT window; receive a configuration for UE-initiated UL transmission; and suppress UE-initiated UL transmissions during at least a portion of the serving cell DBT window.

In some embodiments, the processing circuitry is further operable to perform the steps of any one of the UE methods disclosed herein.

According to one aspect of the present disclosure, a UE configured to handle transmissions in a serving cell DBT window comprises one or more modules configured to: receive a configuration indicating a serving cell DBT window; receive a configuration for UE-initiated UL transmission; and suppress UE-initiated UL transmissions during at least a portion of the serving cell DBT window.

In some embodiments, the one or more modules are further operable to perform the steps of any one of the UE methods disclosed herein.

According to one aspect of the present disclosure, a non-transitory computer readable medium storing software instructions that when executed by one or more processors of a UE configured to handle transmissions in a serving cell Synchronization DBT window, cause the UE to: receive a configuration indicating a serving cell DBT window; receive a configuration for UE-initiated UL transmission; and suppress UE-initiated UL transmissions during at least a portion of the serving cell DBT window.

In some embodiments, the non-transitory computer readable medium further comprises software instructions that when executed by the one or more processors cause the UE to perform the steps of any one of the UE methods disclosed herein.

According to one aspect of the present disclosure, a computer program comprising instructions that when executed by one or more processors of a UE configured to handle transmissions in a serving cell

DBT window, cause the UE to: receive a configuration indicating a serving cell DBT window; receive a configuration for UE-initiated UL transmission; and suppress UE-initiated UL transmissions during at least a portion of the serving cell DBT window.

In some embodiments, the computer program of claim further comprises instructions that when executed by the one or more processors cause the UE to perform the steps of any one of the UE methods disclosed herein.

According to one aspect of the present disclosure, a method, performed at a New Radio (NR) base station (gNB) for handling transmissions in a serving cell DBT window comprises: transmitting, to a UE a configuration indicating a serving cell DBT window; transmitting, to the UE, information indicating a pattern of SSBs to be transmitted by the gNB during the serving cell DBT window; and transmitting SSBs according to the pattern of SSBs to be transmitted by the gNB during the serving cell DBT window.

In some embodiments, transmitting the configuration indicating the serving cell DBT window comprises transmitting a ServingCellConfigCommon IE or a ServingCellConfigCommonSlB IE containing a field that indicates a duration of the serving cell DBT window.

In some embodiments, the field that indicates the duration of the serving cell DBT window comprises a discoveryBurstWindowLength-r16 field.

In some embodiments, transmitting the information indicating the pattern of SSBs to be transmitted by the gNB comprises transmitting an ssb-PositionslnBurst IE.

According to one aspect of the present disclosure, a gNB for handling transmissions in a serving cell DBT window comprises one or more processors and memory comprising instructions that, when executed by the one or more processors, cause the gNB to: transmit, to a UE, a configuration indicating a serving cell DBT window; transmit, to the UE, information indicating a pattern of SSBs to be transmitted by the gNB during the serving cell DBT window; and transmit SSBs according to the pattern of SSBs to be transmitted by the gNB during the serving cell DBT window.

In some embodiments, transmitting the configuration indicating the serving cell DBT window comprises transmitting a ServingCellConfigCommon IE or a ServingCellConfigCommonSIB IE containing a field that indicates a duration of the serving cell DBT window.

In some embodiments, the field that indicates the duration of the serving cell DBT window comprises a discoveryBurstWindowLength-r16 field.

In some embodiments, transmitting the information indicating the pattern of SSBs to be transmitted by the gNB comprises transmitting an ssb-PositionslnBurst IE.

According to one aspect of the present disclosure, a gNB for handling transmissions in a serving cell DBT window comprises radio units and a control system configured to: transmit, to a UE, a configuration indicating a serving cell DBT window; transmit, to the UE, information indicating a pattern of SSBs to be transmitted by the gNB during the serving cell DBT window; and transmit SSBs according to the pattern of SSBs to be transmitted by the gNB during the serving cell DBT window. In some embodiments, the control system is further operable to perform the steps of any one of the gNB methods disclosed herein.

According to one aspect of the present disclosure, a gNB for handling transmissions in a serving cell DBT window comprises one or more modules configured to: transmit, to a UE, a configuration indicating a serving cell DBT window; transmit, to the UE, information indicating a pattern of SSBs to be transmitted by the gNB during the serving cell DBT window; and transmit SSBs according to the pattern of SSBs to be transmitted by the gNB during the serving cell DBT window.

In some embodiments, the one or more modules are further operable to perform the steps of any one of the gNB methods disclosed herein.

According to one aspect of the present disclosure, a non-transitory computer readable medium storing software instructions that when executed by one or more processors of a gNB for handling transmissions in a serving cell DBT window cause the gNB to: transmit, to a UE, a configuration indicating a serving cell DBT window; transmit, to the UE, information indicating a pattern of SSBs to be transmitted by the gNB during the serving cell DBT window; and transmit SSBs according to the pattern of SSBs to be transmitted by the gNB during the serving cell DBT window.

In some embodiments, the non-transitory computer readable medium further comprises software instructions that when executed by the one or more processors cause the gNB to perform the steps of any one of the gNB methods disclosed herein.

According to one aspect of the present disclosure, a computer program comprising instructions that when executed by one or more processors of a gNB for handling transmissions in a serving cell DBT window cause the gNB to: transmit, to a UE, a configuration indicating a serving cell DBT window; transmit, to the UE, information indicating a pattern of SSBs to be transmitted by the gNB during the serving cell DBT window; and transmit SSBs according to the pattern of SSBs to be transmitted by the gNB during the serving cell DBT window.

In some embodiments, the computer program further comprises instructions that when executed by the one or more processors cause the gNB to perform the steps of any one of the gNB methods disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the general mapping of Synchronization Signal (SS)/Physical Broadcast Channel (PBCH) Block (Synchronization Signal Block (SSB)) positions to slots;

FIG. 2 illustrates one example of a cellular communications network according to some embodiments of the present disclosure;

FIG. 3 illustrates a wireless communication system represented as a Fifth Generation (5G) network architecture composed of core Network Functions (NFs), where interaction between any two NFs is represented by a point-to-point reference point/interface;

FIG. 4 illustrates a 5G network architecture using service-based interfaces between the NFs in the control plane, instead of the point-to-point reference points/interfaces used in the 5G network architecture of FIG. 3;

FIG. 5A illustrates a flowchart illustrating an exemplary method for handling of transmissions in the serving cell SSB Measurement Timing Configuration (SMTC) window (also referred to as a Discovery Burst Transmission (DBT) window) by a User Equipment (UE) according to some embodiments of the present disclosure;

FIG. 5B illustrates at a high level some of the ways that a UE may suppress UE-initiated uplink (UL) transmissions according to some embodiments of the present disclosure;

FIG. 6 illustrates a flowchart illustrating an exemplary method for handling transmissions in the serving cell SMTC window by a New Radio (NR) base station (gNB) according to some embodiments of the present disclosure;

FIG. 7 illustrates an exemplary method for handling transmissions in the serving cell SMTC window according to some embodiments of the present disclosure, in which UE-initiated UL transmissions are suppressed during the entire serving cell SMTC window, regardless of where the actual SSBs are presumed present (presumed to be transmitted);

FIG. 8 illustrates an exemplary method for handling transmissions in the serving cell SMTC window according to some embodiments of the present disclosure, in which UE-initiated UL transmissions are suppressed only during symbols in which an SSB is presumed present;

FIG. 9 illustrates an exemplary method for handling transmissions in the serving cell SMTC window according to some embodiments of the present disclosure, in which UE-initiated UL transmissions are suppressed for all symbols in a slot where an SSB is presumed present;

FIG. 10 illustrates an exemplary method for handling transmissions in the serving cell SMTC window according to some embodiments of the present disclosure, in which SSBs are shifted in time and where UE-initiated UL transmissions are suppressed from the beginning of the serving cell SMTC window until the first symbol in which an SSB is presumed present, and afterwards only during symbols in which an SSB is presumed present;

FIG. 11 illustrates an exemplary method for handling transmissions in the serving cell SMTC window according to some embodiments of the present disclosure, in which SSBs are shifted in time and where UE-initiated UL transmissions are suppressed from the beginning of the serving cell SMTC window until the last symbol in which an SSB is presumed present;

FIG. 12 illustrates an exemplary method for handling transmissions in the serving cell SMTC window according to some embodiments of the present disclosure, in which SSBs are shifted in time and where UE-initiated UL transmissions are suppressed until the first symbol in which an SSB is presumed present, and afterwards for all symbols in a slot where an SSB is presumed present;

FIG. 13 is a schematic block diagram of a radio access node according to some embodiments of the present disclosure;

FIG. 14 is a schematic block diagram that illustrates a virtualized embodiment of the radio access node according to some embodiments of the present disclosure;

FIG. 15 is a schematic block diagram of the radio access node according to some other embodiments of the present disclosure;

FIG. 16 is a schematic block diagram of a UE according to some embodiments of the present disclosure;

FIG. 17 is a schematic block diagram of the UE according to some other embodiments of the present disclosure;

FIG. 18 illustrates a communication system according to some embodiments of the present disclosure;

FIG. 19 illustrates another communication system according to some embodiments of the present disclosure;

FIG. 20 is a flowchart illustrating a method implemented in a communication system, in accordance with some embodiments of the present disclosure;

FIG. 21 is a flowchart illustrating a method implemented in a communication system, in accordance with some embodiments of the present disclosure;

FIG. 22 is a flowchart illustrating a method implemented in a communication system, in accordance with some embodiments of the present disclosure; and

FIG. 23 is a flowchart illustrating a method implemented in a communication system, in accordance with some embodiments of the present disclosure.

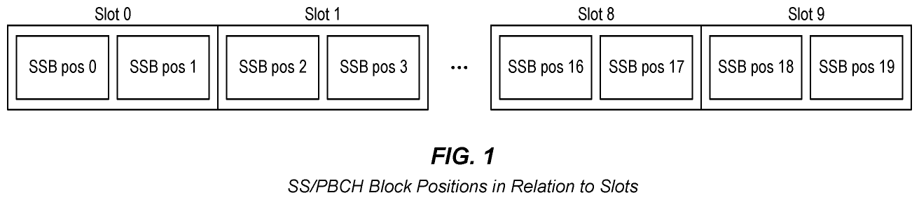

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node. While many examples used herein will refer to a gNB, the present disclosure is not limited thereto.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

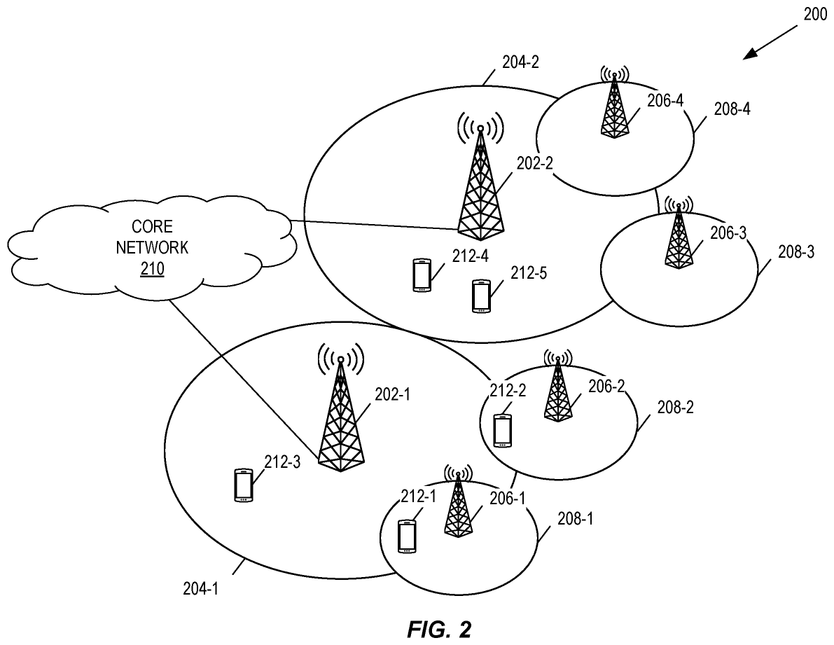

FIG. 2 illustrates one example of a cellular communications network 200 according to some embodiments of the present disclosure. In the embodiments described herein, the cellular communications network 200 is a 5G NR network. In this example, the cellular communications network 200 includes base stations 202-1 and 202-2, which in LTE are referred to as eNBs and in 5G NR are referred to as gNBs, controlling corresponding macro cells 204-1 and 204-2. The base stations 202-1 and 202-2 are generally referred to herein collectively as base stations 202 and individually as base station 202. Likewise, the macro cells 204-1 and 204-2 are generally referred to herein collectively as macro cells 204 and individually as macro cell 204. The cellular communications network 200 may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The base stations 202 (and optionally the low power nodes 206) are connected to a core network 210.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs.

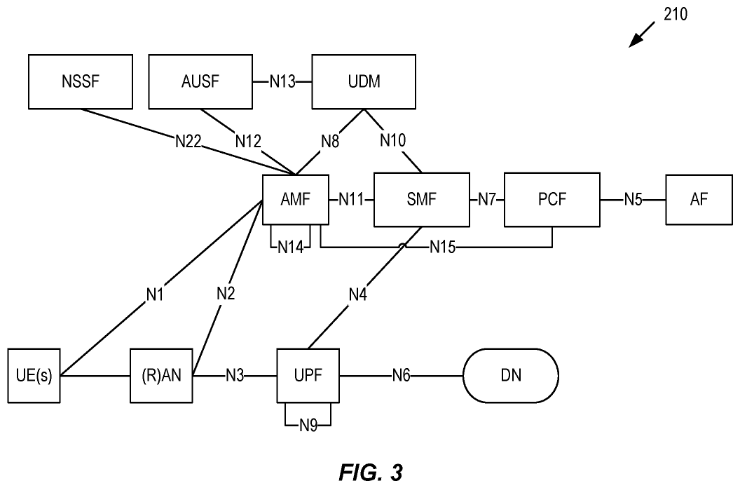

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs connected to either a RAN or an Access Network (AN) as well as an Access and Mobility Management Function (AMF). Typically, the R(AN) comprises base stations, e.g. such as eNBs or gNBs or similar. Seen from the core network side, the 5G core NFs shown in FIG. 3 include a Network Slice Selection Function (NSSF), an Authentication Server Function (AUSF), a Unified Data Management (UDM), an AMF, a Session Management Function (SMF), a Policy Control Function (PCF), and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMF, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 3, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 3. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

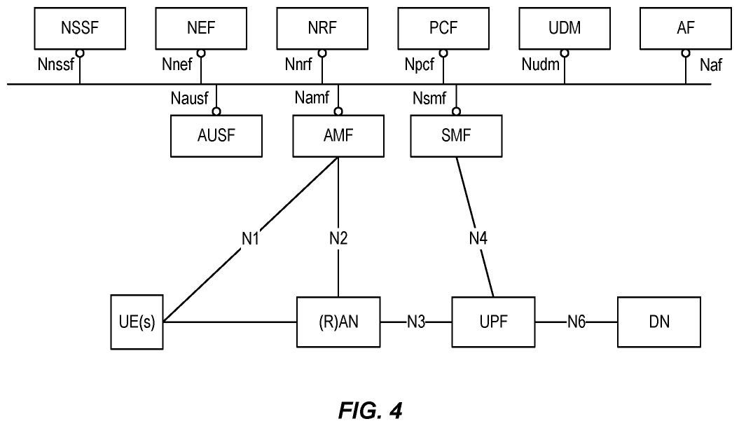

FIG. 4 illustrates a 5G network architecture using service-based interfaces between the NFs in the control plane, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g. Namf for the service based interface of the AMF and Nsmf for the service based interface of the SMF etc. The Network Exposure Function (NEF) and the Network Repository Function (NRF) in FIG. 4 are not shown in

FIG. 3 discussed above. However, it should be clarified that all NFs depicted in FIG. 3 can interact with the NEF and the NRF of FIG. 4 as necessary, though not explicitly indicated in FIG. 3. Some properties of the NFs shown in FIGS. 3 and 4 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

In some embodiments according to the present disclosure, a UE is configured with a serving cell Synchronization Signal Block (SSB) Measurement Timing Configuration (SMTC) window. The SMTC may alternatively be referred to by a variety of names, including, but not limited to, a Discovery Burst Transmission (DBT) window, a serving cell SSB-MTC window, a serving cell Discovery Measurement Timing Configuration (DMTC) window, a Discovery Reference Signal (DRS) transmission window, a Synchronization Signal (SS)/Physical Broadcast Channel (PBCH) block transmission window, a ssb-window, and a Radio Link Management (RLM) window, and other names. In the present disclosure, these terms are used synonymously

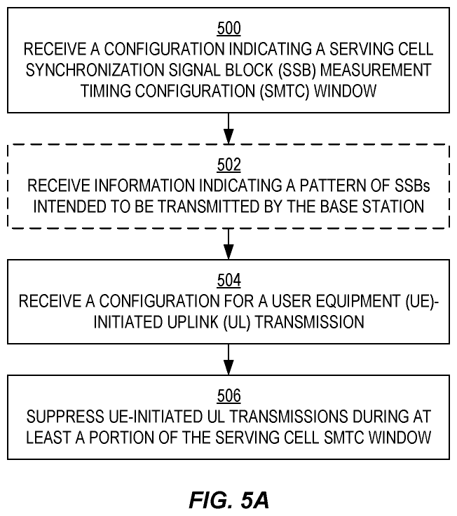

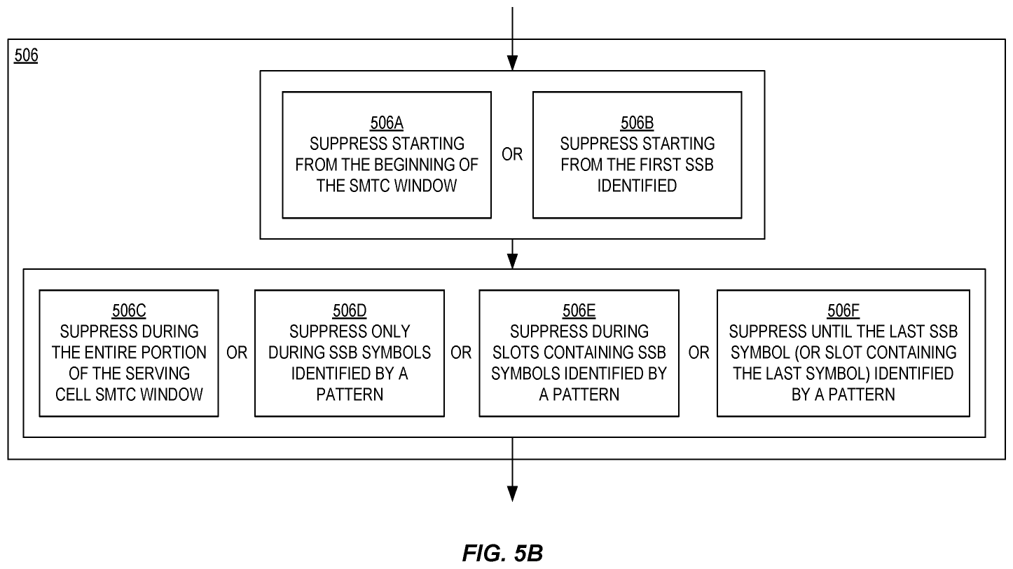

FIG. 5A is a flowchart illustrating an exemplary method for handling of transmissions in the serving cell SMTC window by a UE according to some embodiments of the present disclosure. In the embodiment illustrated in FIG. 5A, the method comprises the following steps. Step 500. A UE receives a configuration indicating a serving cell SMTC. For example, the UE may receive an indication of a location and duration of a serving cell SMTC window. In some embodiments, the serving cell SMTC window is introduced by adding a length field to the ServingCellConfigCommonSIB Information Element (IE) and ServingCellConfigCommon IE as exemplified below. The serving cell SMTC window can also be introduced by adding one instance of the SSB-MTC IE in ServingCellConfigCommonSlB IE and ServingCellConfigCommon IE.

```
  ASN1START
  TAG-SERVINGCELLCONFIGCOMMONSIB-START
```

| ServingCellConfigCommonSIB ::= | SEQUENCE { | | |
|---|---|---|---|
| downlinkConfigCommon | DownlinkConfigCommonSIB, | | |
| uplinkConfigCommon | UplinkConfigCommonSIB | OPTIONAL, | -- Need R |
| supplementaryUplink | UplinkConfigCommonSIB | OPTIONAL, | -- Need R |
| n-TimingAdvanceOffset | ENUMERATED { n0, n25600, n39936 } | | |
| OPTIONAL, -- Need S | | | |
| ssb-PositionsInBurst | SEQUENCE { | | |
| inOneGroup | BIT STRING (SIZE (8)), | | |
| groupPresence | BIT STRING (SIZE (8)) | | |
| OPTIONAL -- Cond Above6GHzOnly | | | |
| | }, | | |
| ssb-PeriodicityServingCell | ENUMERATED {ms5, ms10, ms20, ms40, ms80, | | |
| ms160}, | | | |
| tdd-UL-DL-ConfigurationCommon | TDD-UL-DL-ConfigCommon | | |
| OPTIONAL, -- Cond TDD | | | |
| ss-PBCH-BlockPower | INTEGER (−60..50), | | |
| [symbol] [symbol] [symbol] [symbol] | | | |
| [symbol] | | | |
| | } | | |

```
  TAG-SERVINGCELLCONFIGCOMMONSIB-STOP
  ASN1STOP
  ASN1START
  TAG-SERVING-CELL-CONFIG-COMMON-START
```

| ServingCellConfigCommon ::= | SEQUENCE { | | |
|---|---|---|---|
| physCellId | PhysCellId | | OPTIONAL, |
| -- Cond HOAndServCellAdd | | | |
| downlinkConfigCommon | DownlinkConfigCommon | | |
| OPTIONAL, -- Cond HOAndServCellAdd | | | |
| uplinkConfigCommon | UplinkConfigCommon | OPTIONAL, | -- Need M |
| supplementaryUplinkConfig | UplinkConfigCommon | OPTIONAL, | -- Need S |
| n-TimingAdvanceOffset | ENUMERATED { n0, n25600, n39936 } | | |
| OPTIONAL, -- Need S | | | |
| ssb-PositionsInBurst | CHOICE { | | |
| shortBitmap | BIT STRING (SIZE (4)), | | |
| mediumBitmap | BIT STRING (SIZE (8)), | | |
| longBitmap | BIT STRING (SIZE (64)) | | |
| | } | OPTIONAL, | -- Cond |
| | Abs FreqSSB | | |
| ssb-periodicityServingCell | ENUMERATED {ms5, ms10, ms20, ms40, ms80, | | |
| ms160, spare2, spare1 } | | OPTIONAL, -- | Need S |

| | |
|---|---|
| dmrs-TypeA-Position | ENUMERATED {pos2, pos3}, |
| lte-CRS-ToMatchAround | SetupRelease { RateMatchPatternLTE-CRS } |
| OPTIONAL, -- Need M | |
| rateMatchPatternToAddModList | SEQUENCE (SIZE |

(1..maxNrofRateMatchPatterns)) OF RateMatchPattern

| | |
|---|---|
| OPTIONAL, -- Need N | |
| rateMatchPatternToReleaseList | SEQUENCE (SIZE |

(1..maxNrofRateMatchPatterns)) OF RateMatchPatternId

| | |
|---|---|
| OPTIONAL, -- Need N | |
| subcarrierSpacing | SubcarrierSpacing |

OPTIONAL, -- Cond HOAndServCellAdd

| | |
|---|---|
| tdd-UL-DL-ConfigurationCommon | TDD-UL-DL-ConfigCommon |
| OPTIONAL, -- Cond TDD | |
| ss-PBCH-BlockPower | INTEGER (−60..50), |

[symbol]

[symbol]

[symbol]

[symbol]

[symbol]

}

```
  TAG-SERVING-CELL-CONFIG-COMMON-STOP
  ASN1STOP
```

Step 502. In this optional step, the UE receives information indicating a pattern of SSBs to be transmitted by the gNB. While many examples used herein will refer to a gNB, the present disclosure is not limited thereto. This information may be an SS/PBCH block configuration that indicates SS/PBCH block positions corresponding to the original locations that would be used for transmission without any shifting in time, for example using a bitmap such as the parameter ssb-PositionslnBurst. Step 504. The UE receives a configuration for UE-initiated uplink (UL) transmission. For example, in some embodiments, the UE is configured (as in Release 15 NR) with resources for Scheduling Request (SR) transmissions on Physical Uplink Control Channel (PUCCH) and/or Random Access Channel (RACH) resources on the Physical Random Access Channel (PRACH). The UE can also be configured with configured grant resources.

Step 506. The UE suppresses UE-initiated UL transmissions during at least a portion of the serving cell SMTC window. Where the UE received the pattern of SSBs that the gNB intends to transmit, that pattern may also be taken into account to decide when to suppress the UE-initiated UL transmissions. Various examples of how the UE may suppress UE-initiated UL transmissions will now be described.

FIG. 5B illustrates at a high level some of the ways that a UE may suppress UE-initiated UL transmissions (e.g., step 506 of FIG. 5A) according to some embodiments of the present disclosure. In the embodiment illustrated in FIG. 5B, a UE may begin suppression of UE-initiated UL transmissions from the start of the serving cell SMTC window (step 506A), or it may choose not to suppress the UE-initiated UL transmissions until it detect the first SSB (step 506B). The same approaches may be used both in cases where the SSBs are transmitted on time by the gNB or where the SSBs are delayed in time by the gNB, e.g., due to a Listen-Before-Talk (LBT) delay while the gNB waits for the channel to become available.

In any case, in the embodiment illustrated in FIG. 5B, the UE then has options about when to suppress the UE-initiated UL transmissions and for how long. In FIG. 5B, for example, the UE may choose to suppress UE-initiated UL transmissions for the entire duration of the serving cell SMTC window, regardless of when the SSBs may be transmitted by the gNB (step 506C); it may suppress UE-initiated UL transmissions only during SSB symbols identified by a pattern of intended transmissions (step 506D); it may suppress UE-initiated UL transmissions during all of the symbols of any slot that contains SSB symbols identified by the pattern of intended transmissions (step 506E); or it may suppress UE-initiated UL transmissions until the last SSB in the pattern of intended SSB transmissions (or until the end of the last slot containing the last intended SSB transmission), including during SSBs during which the gNB does not intend to transmit during that interval (step 506F). It will be noted that these examples are illustrative and not limiting.

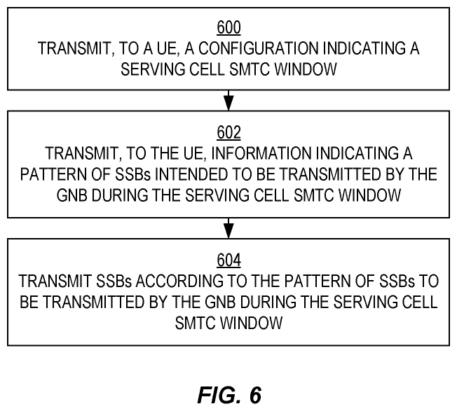

FIG. 6 is a flowchart illustrating an exemplary method for handling transmissions in the serving cell SMTC window by a gNB according to some embodiments of the present disclosure. In the embodiment illustrated in FIG. 6, the method comprises the following steps.

Step 600. Transmit, to a UE, a configuration indicating a serving cell SMTC window. In some embodiments, this comprises transmitting an information element in either dedicated signaling or broadcast signaling containing a field that indicates a duration of the serving cell DBT window. In some embodiments, the field in dedicated signaling is a ServingCellConfigCommon IE or ServingCellConfigCommonSIB IE containing a field that indicates a duration of the serving cell SMTC window. In some embodiments, the field that indicates the duration of the serving cell SMTC window comprises a discoveryBurstWindowLength-r16 field.

Step 602. Transmit, to the UE, information indicating a pattern of SSBs to be transmitted by the gNB during the serving cell SMTC window. In some embodiments, transmitting the information indicating a pattern of SSBs to be transmitted by the gNB comprises transmitting a bitmap that indicates the pattern. In some embodiments, the bitmap is contained in an ssb-PositionslnBurst IE.

Step 604. Transmit SSBs according to the pattern of SSBs to be transmitted by the gNB during the serving cell SMTC window.

### Serving Cell SMTC Window

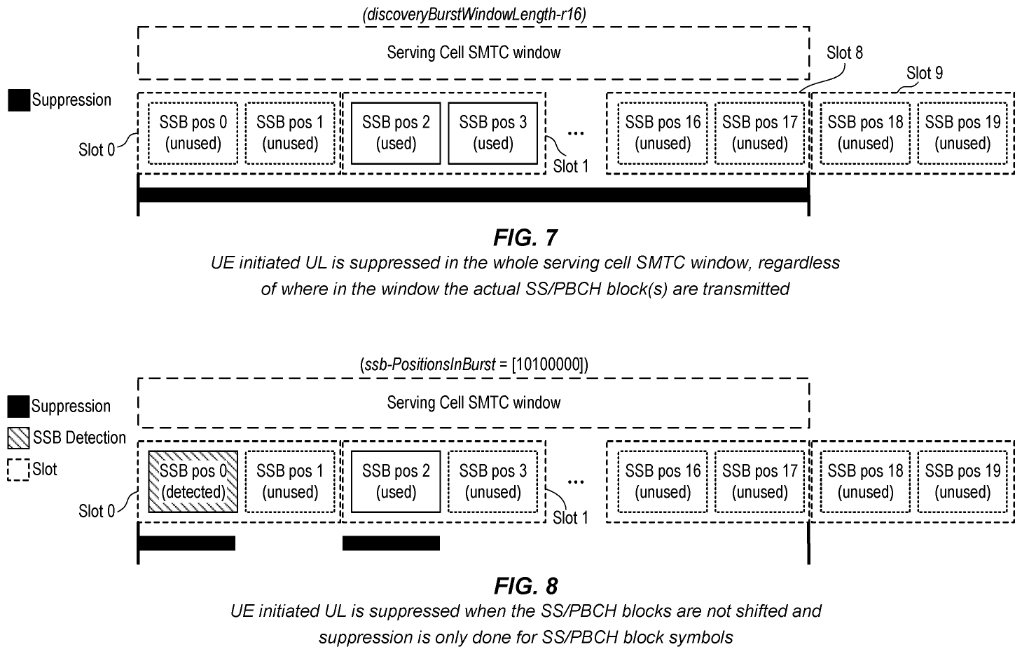

FIG. 7 illustrates an exemplary serving cell SMTC window according to some embodiments of the present disclosure. In the embodiment illustrated in FIG. 7, the serving cell SMTC window occupies the first nine slots (slots 0-8), which includes 18 SSB positions or opportunities, labeled “SSB pos 0” through “SSB pos 17” in FIG. 7.

### Suppress During the Entire Serving Cell SMTC Window

FIG. 7 also illustrates an exemplary method for handling transmissions in the serving cell SMTC window according to some embodiments of the present disclosure, in which UE-initiated UL transmissions are suppressed during the entire serving cell SMTC window, regardless of where the actual SSBs are presumed present (presumed to be transmitted). In these embodiments, the UE will suppress UE-initiated UL transmissions (such as PRACH and SR) during the entire serving cell SMTC window. Note that scheduled (as opposed to UE-initiated) UL transmissions such as Physical Uplink Shared Channel (PUSCH) and PUCCH transmissions as a response to a downlink (DL) transmission, for example Hybrid Automatic Repeat Request (HARQ) Acknowledgement (ACK)/Negative Acknowledgements (NACKs), triggered aperiodic Channel Quality Information (CQI) reports, triggered aperiodic Sounding Reference Signal (SRS) transmissions, etc., are not suppressed since the gNB has knowledge of where the SSBs are transmitted and can thus avoid these locations by proper scheduling. Here, the term “suppressed” means that even if the UE is configured with a valid UL resource it will not use the resource at this occasion.

### Suppress until the Last SSB has Been Transmitted by the gNB

In other embodiments according to the subject matter of the present disclosure, the UE suppresses the UE-initiated UL transmission only until it has determined that the gNB has transmitted all SS/PBCH block(s) it intends to transmit, after which UE-initiated UL transmission is not suppressed, at least until the next serving cell SMTC window. The following figures show various embodiments of this basic concept.

As will be seen in the following figures, in some embodiments, in addition to the serving cell SMTC window configuration, the UE bases its suppression decision on detection of transmitted SSBs. In some embodiments, this determining is based on the UE detecting the first of several expected SSBs, after which the UE presumes that the gNB will continue to transmit according to the announced pattern. The detection can be done for example by correlating to any combination of signals that are part of the SS/PBCH block and comparing the correlation result to a threshold. Alternatively, the detection can be done by decoding the PBCH and checking if the Cyclic Redundancy Check (CRC) checks.

As will also be seen in the following figures, there are a number of ways to deal with the situation where the SSBs are shifted, e.g., due to the delay to detect an open channel (e.g., LBT). In some embodiments, the UE-initiated UL transmission is suppressed from the beginning of the serving cell SMTC window until the first SSB is detected; in other embodiments, the UE-initiated UL transmission is not suppressed until the first SSB is detected. In either of the above embodiments, once the first SSB is detected, it may be presumed that the subsequent SSBs will follow the announced pattern. As will also be seen in the following figures, once the first SSB is detected, the UE may (a) suppress all UE-initiated UL transmissions until the last SSB symbols, even if intervening symbols are not used for SSB, (b) suppress all UE-initiated UL transmissions only during symbols actually used for SSB, or (c) suppress all UE-initiated UL transmissions during any slot that contains any symbols actually used for SSB.

FIG. 8 illustrates an exemplary method for handling transmissions in the serving cell SMTC window according to some embodiments of the present disclosure, in which UE-initiated UL transmissions are suppressed only during symbols in which an SSB is presumed present, i.e. only during SS/PBCH block symbols. In the example illustrated in FIG. 8, the gNB has notified the UE that it intends to transmit SSBs in positions 0 and 2 but not in positions 1, 3, 4, 5, 6, or 7, e.g., by sending the UE a ssb-PositionslnBurst IE having the value [1 0 1 0 0 0 0 0].

In the embodiment illustrated in FIG. 8, the UE determines that the SS/PBCH block transmissions from the gNB are not shifted in time. That is, the gNB has acquired access to the channel before the first SS/PBCH block position it intends to transmit in the serving cell SMTC window and has transmitted that (and subsequent) SS/PBCH block(s). The UE can determine this by finding the position of the first bit set to ‘1’ in the Release 15 NR ssb-PositionsInBurst IE. The UE then checks if an SS/PBCH block was present in the corresponding SS/PBCH block position. Then, the UE would check if an SS/PBCH block is present in the first SS/PBCH block position in the serving cell SMTC window. If the UE detected an SS/PBCH block in the correct position (as indicated by the first bit set to one in ssb-PositionslnBurst) it will then assume that SSBs are present in the SS/PBCH positions indicated by ssb-PositionslnBurst. In the example above, the UE would assume that SSBs are present in positions 0 and 2. Consequently, the UE would then suppress transmissions in symbols at least corresponding to those occupied by SSBs in these positions. In some embodiments, the UE would not only suppress transmissions in symbols corresponding to the SS/PBCH block positions for which bits were set to one in ssb-PositionslnBurst, but also for symbols corresponding to potential transmissions of system information (Remaining System Information (RMSI)) associated with those SSBs.

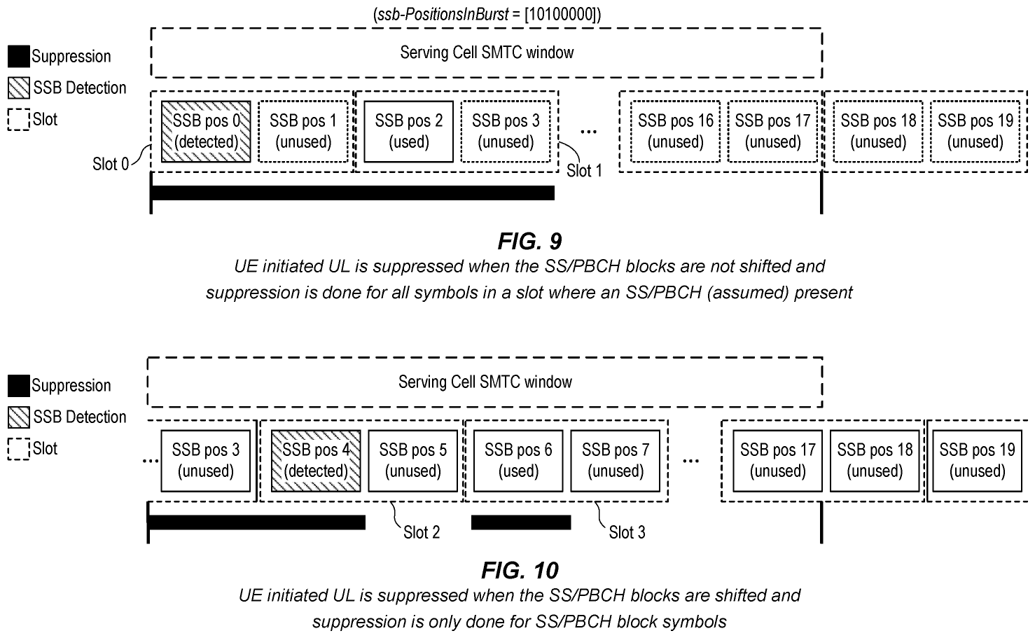

FIG. 9 illustrates an exemplary method for handling transmissions in the serving cell SMTC window according to some embodiments of the present disclosure, in which UE-initiated UL transmissions are suppressed for all symbols in a slot where an SSB is presumed present. In the embodiment illustrated in FIG. 9, for example, the UE would not only suppress transmissions in symbols corresponding to bits set to one in ssb-PositionslnBurst, but also in any symbol in a slot that has at least one of the two SS/PBCH block positions associated with it set to one in ssb-PositionslnBurst. For example, using the same value for ssb-PositionslnBurst as was used FIG. 8, in the specific example shown in FIG. 9, the UE would suppress transmissions in both the first and second slot, because the first bit of “[ 1 0 1 0 0 0 0 ]” set to one corresponds to the first SS/PBCH position in the first slot and the second bit of “[ 1 0 1 0 0 0 0 0]” set to one (the third bit) corresponds to the first SS/PBCH position in the second slot.

FIG. 10 illustrates an exemplary method for handling transmissions in the serving cell SMTC window according to some embodiments of the present disclosure, in which SSBs are shifted in time and where UE-initiated UL transmissions are suppressed from the beginning of the serving cell SMTC window until the first symbol in which an SSB is presumed present, and afterwards only during symbols in which an SSB is presumed present. This may be done by taking into account the uncertainty at the UE regarding the particular SSB that has been detected within the ones corresponding to the bits set to one in ssb-PositionslnBurst. In the specific example shown in FIG. 10, where the ssb-PositionsInBurst=[1 0 1 0 0 0 0 0], if the UE detects an SS/PBCH block in position 4, the UE will suppress transmissions in symbols corresponding to SSB positions 0, 1, 2, 3, 4, and 6 in the serving cell SMTC window.

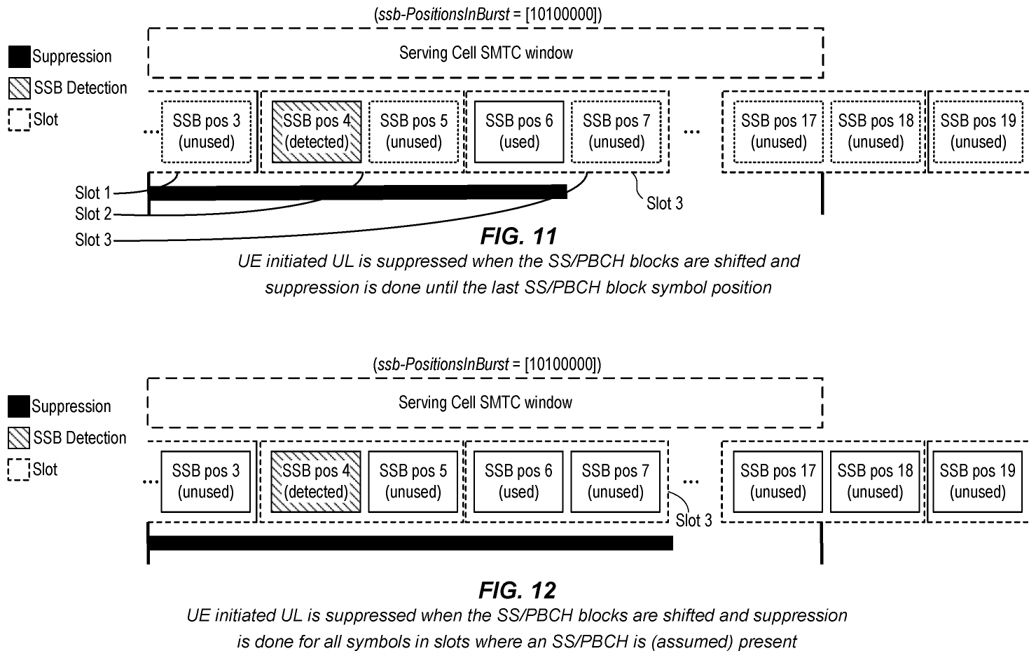

FIG. 11 illustrates an exemplary method for handling transmissions in the serving cell SMTC window according to some embodiments of the present disclosure, in which SSBs are shifted in time and where UE-initiated UL transmissions are suppressed from the beginning of the serving cell SMTC window until the last symbol in which an SSB is presumed present. In the embodiment illustrated in FIG. 11, the UE suppresses UL transmissions for all symbols from the start of the serving cell SMTC window until the last symbol corresponding to the SS/PBCH block position corresponding to the last ‘1’ in ssb-PositionslnBurst has been transmitted.

In the specific example shown in FIG. 11, the gNB was not able to transmit during the first slot, e.g. as a result of a LBT operation. As in the previous example, the UE assumes that the detected SS/PBCH block corresponds to the first ‘1’ in ssb-PositionslnBurst. For example, if ssb-PositionsInBurst=[1 0 1 0 0 0 0 0] and the UE detects an SS/PBCH block in position 4, the UE will suppress UL transmissions from the start of the serving cell SMTC window until the last symbol of SS/PBCH block position 4+2=6 (because the last ‘1’ in ssb-PositionsInBurst is in position 2, with numbering starting from 0).

FIG. 12 illustrates an exemplary method for handling transmissions in the serving cell SMTC window according to some embodiments of the present disclosure, in which SSBs are shifted in time and where UE-initiated UL transmissions are suppressed until the first symbol in which an SSB is presumed present, and afterwards for all symbols in a slot where an SSB is presumed present. FIG. 12 illustrates a variation on the method illustrated in FIG. 11, in which the UE would not only suppress transmissions in symbols corresponding to bits set to one in ssb-PositionslnBurst, but also in any symbol in a slot that has at least one of the two SS/PBCH block positions associated with it set to one in ssb-PositionslnBurst. In the specific example shown in FIG. 12, the UE would suppress transmissions in all symbols in slots in the serving cell SMTC window until the end of slot 3. Other variants are also contemplated by the present disclosure. For example, in some embodiments, the UE would not only suppress transmissions in symbols corresponding to the SS/PBCH block positions where an SS/PBCH block transmission is considered possible, but also for symbols corresponding to potential transmissions of system information (RMSI) associated with those SSBs.

### Rate Matching

In this group of embodiments, the UE uses existing rate matching mechanisms for reception of Physical Downlink Shared Channel (PDSCH) that are already part of the NR specification but typically used for rate matching around reserved resources which may contain signals from other technologies. In this group of embodiments, these rate matching mechanisms are used by the UE to rate match around actual transmitted SS/PBCH block(s) that are transmitted within the DRS transmission window due to various constraints including restrictions on accessing the channel at particular times. The UE is provided with an SS/PBCH block configuration that indicates SS/PBCH block positions corresponding to the original locations that would be used for transmission without any shifting in time, for example using a bitmap such as the parameter ssb-PositionslnBurst. The rate matching patterns are configured, however, to map to all possible locations of the SS/PBCH block transmissions in the DRS transmission window based on dynamic shifting of the SS/PBCH block transmissions due to channel conditions. In some embodiments, the rate matching patterns provided to the UE are based on the pattern of SSBs intended to be transmitted by the radio access node (e.g., ssb-PositionslnBurst) and a periodicity and pattern bitmap (e.g., the bitmap n20) that indicates the duration of the DBT window within the indicated rate matching pattern period. In some embodiments, the rate matching patterns are provided to the UE semi-statically. In some embodiments, the rate matching mechanism for reception of the Physical Downlink Shared Channel (PDSCH) includes the UE receiving a ‘1’ in the DCI that schedules the PDSCH which indicates that PDSCH is to be rate matched around the reserved resources or the UE receiving a ‘0’ which indicates that the reserved resources are available for PDSCH reception.

Through a combination of the indicated bitmap, e.g., ssb-PositionslnBurst, and the indicated rate matching pattern(s), the UE determines whether or not it should rate match PDSCH around a set of Resource Blocks (RBs) corresponding to an SS/PBCH block. The rate matching behavior could be different in the original and shifted SS/PBCH block locations within a DRS transmission window. For example, the UE may always rate match around the non-shifted SS/PBCH block locations indicated in ssb-PositionslnBurst irrespective of the indication in the Downlink Control Information (DCI) message while it follows this indication in other SS/PBCH block locations to determine if the resources potentially occupied by the SS/PBCH block should be rate matched around or not.

The rate matching patterns are configured via Radio Resource Control (RRC) as described in Technical Specification (TS) 38.331 and their use is described in TS 38.214, clause 5.1.4.1. The RateMatchPattern IE configured via RRC is shown further below.

[symbol]

information element

```
  ASN1START
  TAG-RATEMATCHPATTERN-START
```

| | |
|---|---|
| RateMatchPattern ::= | SEQUENCE { |
| rateMatchPatternId | RateMatchPatternId, |
| patternType | CHOICE { |
| bitmaps | SEQUENCE { |
| resourceBlocks | BIT STRING (SIZE (275)), |
| symbolsInResourceBlock | CHOICE { |
| oneSlot | BIT STRING (SIZE (14)), |
| twoSlots | BIT STRING (SIZE (28)) |
| | }, |
| periodicityAndPattern | CHOICE { |
| n2 | BIT STRING (SIZE (2)), |
| n4 | BIT STRING (SIZE (4)), |
| n5 | BIT STRING (SIZE (5)), |
| n8 | BIT STRING (SIZE (8)), |
| n10 | BIT STRING (SIZE (10)), |
| n20 | BIT STRING (SIZE (20)), |
| n40 | BIT STRING (SIZE (40)) |
| | } OPTIONAL, -- Need S |
| . . . | |
| | }, |
| controlResourceSet | ControlResourceSetId |
| | }, |
| subcarrierSpacing | SubcarrierSpacing |
| OPTIONAL, -- Cond CellLevel | |
| dummy | ENUMERATED { dynamic, semiStatic }, |
| . . . | |
| | } |
| TAG-RATEMATCHPATTERN-STOP | |
| ASN1STOP | |

An example configuration that can achieve the purpose of enabling dynamic rate matching around SS/PBCH block(s) transmissions is as follows.

The RateMatchPattern IE is configured with:
A Subcarrier Spacing (SCS) as appropriate, e.g., 30 kilohertz (kHz);
A RB level bitmap resourceBlocks configured to blank out an SS/PBCH block in the appropriate position within the Bandwidth Part (BWP);
A symbol level bitmap symbolslnResourceBlock configured with duration=one slot with value equal to the time domain SS/PBCH block pattern used, e.g., [0 0 1 1 1 1 0 0 1 1 1 1 0 0] (Case C pattern 30 kHz SCS);
Periodicity and pattern bitmap periodicityAndPattern configured for 20 slots (one radio frame at 30 kHz SCS=10 ms) as follows: n20=[1 1 1 1 1 1 1 1 1 1 0 0 0 0 0 0 0 0 0 0] with the intention that it configures reserved resources in DRS transmission windows of 5 milliseconds (ms) (via the set of in the bitmap)
The n20 bitmap repeats itself every 10 ms (periodicity=10 ms)
The rate matching configured to be controlled dynamically by setting the corresponding field to ‘dynamic’;

Configure the above pattern as a single RateMatchPattern within rateMatchPatternGroup1. The DCI field “Rate matching Indicator” is configured to contain one bit that corresponds to this rate matching pattern group. This bit is included in the DCI message scheduling the PDSCH and can dynamically control rate matching around the SS/PBCH block.
If ‘1’ is indicated in DCI 1_1 that schedules PDSCH, then PDSCH is rate matched around the reserved resources which perfectly overlap with the SS/PBCH block in the scheduled slot.
If ‘0’ is indicated, then the reserved resources are available.

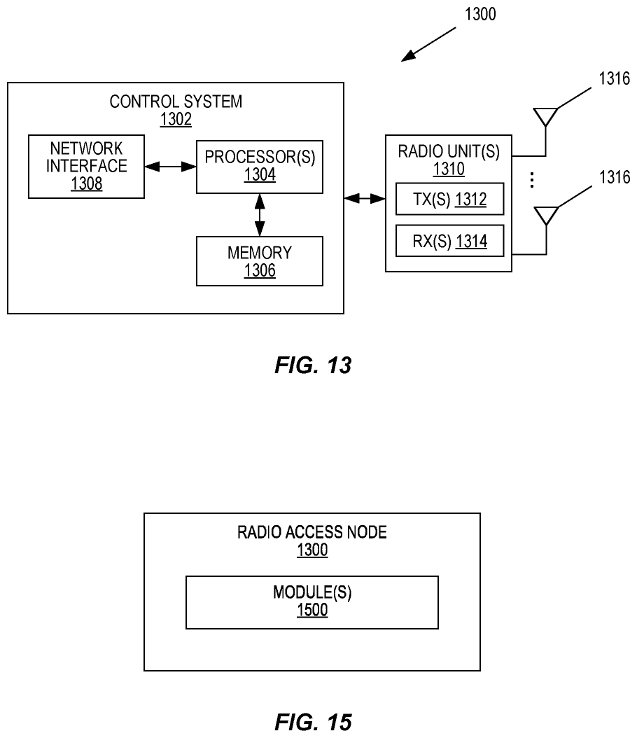

FIG. 13 is a schematic block diagram of a radio access node 1300 according to some embodiments of the present disclosure. The radio access node 1300 may be, for example, a base station 202 or 206. As illustrated, the radio access node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the radio access node 1300 includes one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of a radio access node 1300 as described herein. In some embodiments, the function(s) are implemented in software that is stored, e.g., in the memory 1306 and executed by the one or more processors 1304.

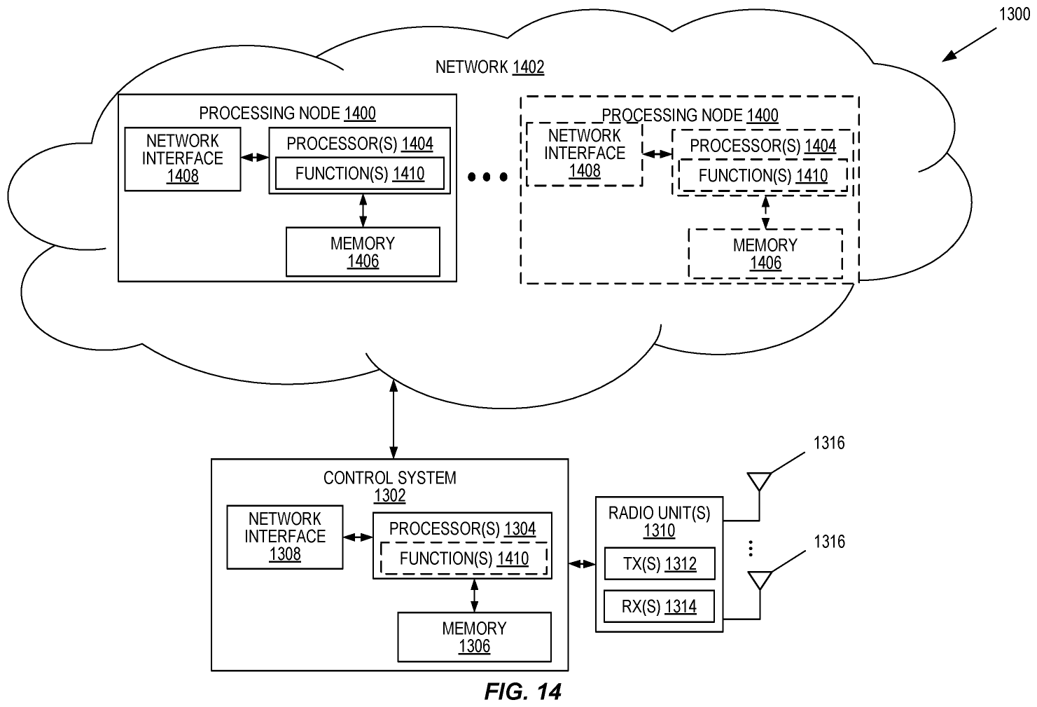

FIG. 14 is a schematic block diagram that illustrates a virtualized embodiment of the radio access node 1300 according to some embodiments of the present disclosure. This discussion is equally applicable to other types of network nodes. Further, other types of network nodes may have similar virtualized architectures.

As used herein, a “virtualized” radio access node is an implementation of the radio access node 1300 in which at least a portion of the functionality of the radio access node 1300 is implemented as a virtual component(s) (e.g., via a virtual machine(s) executing on a physical processing node(s) in a network(s)). As illustrated, in this example, the radio access node 1300 includes the control system 1302 that includes the one or more processors 1304 (e.g., CPUs, ASICs, FPGAs, and/or the like), the memory 1306, and the network interface 1308 and the one or more radio units 1310 that each includes the one or more transmitters 1312 and the one or more receivers 1314 coupled to the one or more antennas 1316, as described above. The control system 1302 is connected to the radio unit(s) 1310 via, for example, an optical cable or the like. The control system 1302 is connected to one or more processing nodes 1400 coupled to or included as part of a network(s) 1402 via the network interface 1308. Each processing node 1400 includes one or more processors 1404 (e.g., CPUs, ASICs, FPGAs, and/or the like), memory 1406, and a network interface 1408.

In this example, functions 1410 of the radio access node 1300 described herein are implemented at the one or more processing nodes 1400 or distributed across the control system 1302 and the one or more processing nodes 1400 in any desired manner. In some particular embodiments, some or all of the functions 1410 of the radio access node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case a radio unit 1310 can communicate directly with the processing node(s) 1400 via an appropriate network interface(s).

In some embodiments, a computer program including instructions which, when executed by at least one processor, causes the at least one processor to carry out the functionality of radio access node 1300 or a node (e.g., a processing node 1400) implementing one or more of the functions 1410 of the radio access node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the radio access node 1300 according to some other embodiments of the present disclosure. The radio access node 1300 includes one or more modules 1500, each of which is implemented in software. The module(s) 1500 provide the functionality of the radio access node 1300 described herein. This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

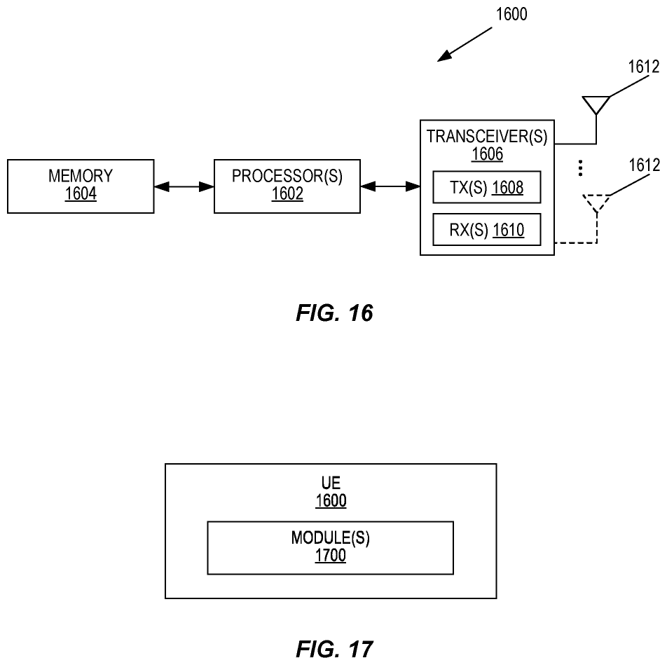

FIG. 16 is a schematic block diagram of a UE 1600 according to some embodiments of the present disclosure. As illustrated, the UE 1600 includes one or more processors 1602 (e.g., CPUs, ASICs, FPGAs, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the UE 1600 described above may be fully or partially implemented in software that is, e.g., stored in the memory 1604 and executed by the processor(s) 1602. Note that the UE 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the UE 1600 and/or allowing output of information from the UE 1600), a power supply (e.g., a battery and associated power circuitry), etc.

In some embodiments, a computer program including instructions which, when executed by at least one processor, causes the at least one processor to carry out the functionality of the UE 1600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the UE 1600 according to some other embodiments of the present disclosure. The UE 1600 includes one or more modules 1700, each of which is implemented in software. The module(s) 1700 provide the functionality of the UE 1600 described herein.

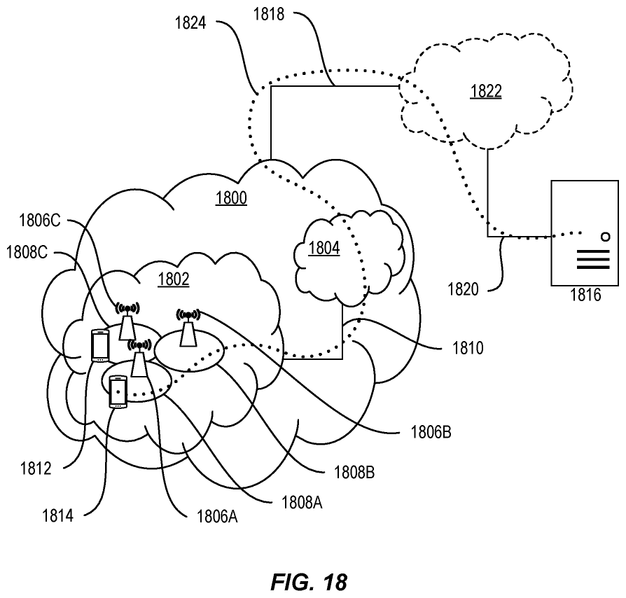

FIG. 18 illustrates a communication system according to some embodiments of the present disclosure. With reference to FIG. 18, in accordance with an embodiment, a communication system includes a telecommunication network 1800, such as a 3GPP-type cellular network, which comprises an access network 1802, such as a RAN, and a core network 1804. The access network 1802 comprises a plurality of base stations 1806A, 1806B, 1806C, such as Node Bs, eNBs, gNBs, or other types of wireless Access Points (APs), each defining a corresponding coverage area 1808A, 1808B, 1808C. Each base station 1806A, 1806B, 1806C is connectable to the core network 1804 over a wired or wireless connection 1810. A first UE 1812 located in coverage area 1808C is configured to wirelessly connect to, or be paged by, the corresponding base station 1806C. A second UE 1814 in coverage area 1808A is wirelessly connectable to the corresponding base station 1806A. While a plurality of UEs 1812, 1814 are illustrated in this example, the disclosed embodiments are equally applicable to a situation where a sole UE is in the coverage area or where a sole UE is connecting to the corresponding base station 1806.

The telecommunication network 1800 is itself connected to a host computer 1816, which may be embodied in the hardware and/or software of a standalone server, a cloud-implemented server, a distributed server, or as processing resources in a server farm. The host computer 1816 may be under the ownership or control of a service provider, or may be operated by the service provider or on behalf of the service provider. Connections 1818 and 1820 between the telecommunication network 1800 and the host computer 1816 may extend directly from the core network 1804 to the host computer 1816 or may go via an optional intermediate network 1822. The intermediate network 1822 may be one of, or a combination of more than one of, a public, private, or hosted network; the intermediate network 1822, if any, may be a backbone network or the Internet; in particular, the intermediate network 1822 may comprise two or more sub-networks (not shown).

The communication system of FIG. 18 as a whole enables connectivity between the connected UEs 1812, 1814 and the host computer 1816. The connectivity may be described as an Over-the-Top (OTT) connection 1824. The host computer 1816 and the connected UEs 1812, 1814 are configured to communicate data and/or signaling via the OTT connection 1824, using the access network 1802, the core network 1804, any intermediate network 1822, and possible further infrastructure (not shown) as intermediaries. The OTT connection 1824 may be transparent in the sense that the participating communication devices through which the OTT connection 1824 passes are unaware of routing of uplink and downlink communications. For example, the base station 1806 may not or need not be informed about the past routing of an incoming downlink communication with data originating from the host computer 1816 to be forwarded (e.g., handed over) to a connected UE 1812. Similarly, the base station 1806 need not be aware of the future routing of an outgoing uplink communication originating from the UE 1812 towards the host computer 1816.

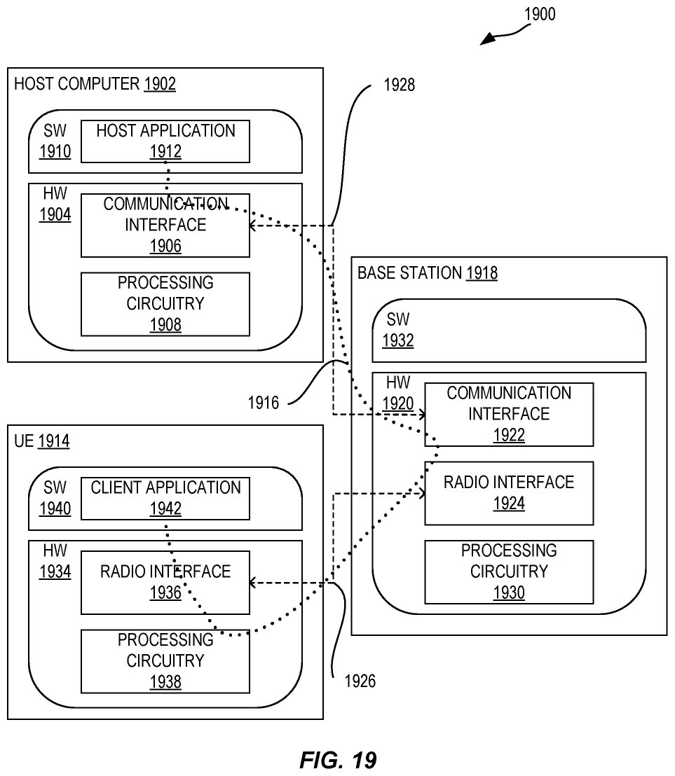

FIG. 19 illustrates another communication system according to some embodiments of the present disclosure. Example implementations, in accordance with an embodiment, of the UE, base station, and host computer discussed in the preceding paragraphs will now be described with reference to FIG. 19. In a communication system 1900, a host computer 1902 comprises hardware 1904 including a communication interface 1906 configured to set up and maintain a wired or wireless connection with an interface of a different communication device of the communication system 1900. The host computer 1902 further comprises processing circuitry 1908, which may have storage and/or processing capabilities. In particular, the processing circuitry 1908 may comprise one or more programmable processors, ASICs, FPGAs, or combinations of these (not shown) adapted to execute instructions. The host computer 1902 further comprises software 1910, which is stored in or accessible by the host computer 1902 and executable by the processing circuitry 1908. The software 1910 includes a host application 1912. The host application 1912 may be operable to provide a service to a remote user, such as a UE 1914 connecting via an OTT connection 1916 terminating at the UE 1914 and the host computer 1902. In providing the service to the remote user, the host application 1912 may provide user data which is transmitted using the OTT connection 1916.

The communication system 1900 further includes a base station 1918 provided in a telecommunication system and comprising hardware 1920 enabling it to communicate with the host computer 1902 and with the UE 1914. The hardware 1920 may include a communication interface 1922 for setting up and maintaining a wired or wireless connection with an interface of a different communication device of the communication system 1900, as well as a radio interface 1924 for setting up and maintaining at least a wireless connection 1926 with the UE 1914 located in a coverage area (not shown in FIG. 19) served by the base station 1918. The communication interface 1922 may be configured to facilitate a connection 1928 to the host computer 1902. The connection 1928 may be direct or it may pass through a core network (not shown in FIG. 19) of the telecommunication system and/or through one or more intermediate networks outside the telecommunication system. In the embodiment shown, the hardware 1920 of the base station 1918 further includes processing circuitry 1930, which may comprise one or more programmable processors, ASICs, FPGAs, or combinations of these (not shown) adapted to execute instructions. The base station 1918 further has software 1932 stored internally or accessible via an external connection.

The communication system 1900 further includes the UE 1914 already referred to. The UE's 1914 hardware 1934 may include a radio interface 1936 configured to set up and maintain a wireless connection 1926 with a base station serving a coverage area in which the UE 1914 is currently located. The hardware 1934 of the UE 1914 further includes processing circuitry 1938, which may comprise one or more programmable processors, ASICs, FPGAs, or combinations of these (not shown) adapted to execute instructions. The UE 1914 further comprises software 1940, which is stored in or accessible by the UE 1914 and executable by the processing circuitry 1938. The software 1940 includes a client application 1942. The client application 1942 may be operable to provide a service to a human or non-human user via the UE 1914, with the support of the host computer 1902. In the host computer 1902, the executing host application 1912 may communicate with the executing client application 1942 via the OTT connection 1916 terminating at the UE 1914 and the host computer 1902. In providing the service to the user, the client application 1942 may receive request data from the host application 1912 and provide user data in response to the request data. The OTT connection 1916 may transfer both the request data and the user data. The client application 1942 may interact with the user to generate the user data that it provides.

It is noted that the host computer 1902, the base station 1918, and the UE 1914 illustrated in FIG. 19 may be similar or identical to the host computer 1816, one of the base stations 1806A, 1806B, 1806C, and one of the UEs 1812, 1814 of FIG. 18, respectively. This is to say, the inner workings of these entities may be as shown in FIG. 19 and independently, the surrounding network topology may be that of FIG. 18.

In FIG. 19, the OTT connection 1916 has been drawn abstractly to illustrate the communication between the host computer 1902 and the UE 1914 via the base station 1918 without explicit reference to any intermediary devices and the precise routing of messages via these devices. The network infrastructure may determine the routing, which may be configured to hide from the UE 1914 or from the service provider operating the host computer 1902, or both. While the OTT connection 1916 is active, the network infrastructure may further take decisions by which it dynamically changes the routing (e.g., on the basis of load balancing consideration or reconfiguration of the network).

The wireless connection 1926 between the UE 1914 and the base station 1918 is in accordance with the teachings of the embodiments described throughout this disclosure. One or more of the various embodiments improve the performance of OTT services provided to the UE 1914 using the OTT connection 1916, in which the wireless connection 1926 forms the last segment. More precisely, the teachings of these embodiments may improve the UEs ability to handle transmissions during the serving cell SMTC window and thereby provide benefits such as allowing the UE and gNB to avoid competing for access to the channel in the serving cell SMTC window, and, in some embodiments, preventing the UE from unnecessarily suppressing UL transmissions when the gNB has already transmitted the SSBs in the window.

A measurement procedure may be provided for the purpose of monitoring data rate, latency, and other factors on which the one or more embodiments improve. There may further be an optional network functionality for reconfiguring the OTT connection 1916 between the host computer 1902 and the UE 1914, in response to variations in the measurement results. The measurement procedure and/or the network functionality for reconfiguring the OTT connection 1916 may be implemented in the software 1910 and the hardware 1904 of the host computer 1902 or in the software 1940 and the hardware 1934 of the UE 1914, or both. In some embodiments, sensors (not shown) may be deployed in or in association with communication devices through which the OTT connection 1916 passes; the sensors may participate in the measurement procedure by supplying values of the monitored quantities exemplified above, or supplying values of other physical quantities from which the software 1910, 1940 may compute or estimate the monitored quantities. The reconfiguring of the OTT connection 1916 may include message format, retransmission settings, preferred routing, etc.; the reconfiguring need not affect the base station 1918, and it may be unknown or imperceptible to the base station 1918. Such procedures and functionalities may be known and practiced in the art. In certain embodiments, measurements may involve proprietary UE signaling facilitating the host computer 1902's measurements of throughput, propagation times, latency, and the like. The measurements may be implemented in that the software 1910 and 1940 causes messages to be transmitted, in particular empty or ‘dummy’ messages, using the OTT connection 1916 while it monitors propagation times, errors, etc.

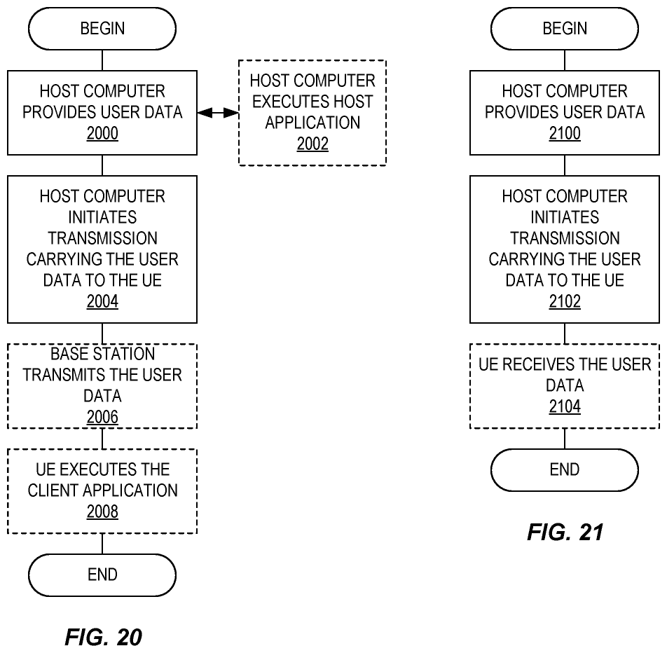

FIG. 20 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 20 will be included in this section. In step 2000, the host computer provides user data. In sub-step 2002 (which may be optional) of step 2000, the host computer provides the user data by executing a host application. In step 2004, the host computer initiates a transmission carrying the user data to the UE. In step 2006 (which may be optional), the base station transmits to the UE the user data which was carried in the transmission that the host computer initiated, in accordance with the teachings of the embodiments described throughout this disclosure. In step 2008 (which may also be optional), the UE executes a client application associated with the host application executed by the host computer.

FIG. 21 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 21 will be included in this section. In step 2100 of the method, the host computer provides user data. In an optional sub-step (not shown) the host computer provides the user data by executing a host application. In step 2102, the host computer initiates a transmission carrying the user data to the UE. The transmission may pass via the base station, in accordance with the teachings of the embodiments described throughout this disclosure. In step 2104 (which may be optional), the UE receives the user data carried in the transmission.

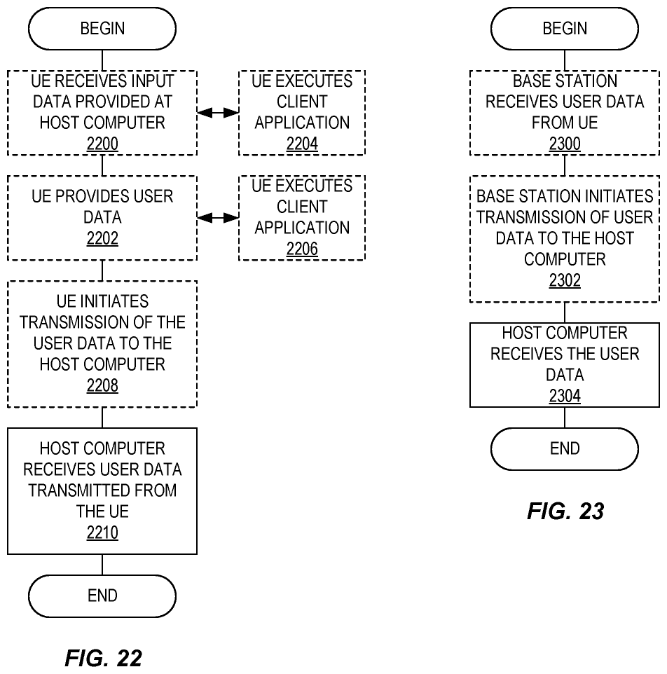

FIG. 22 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 22 will be included in this section. In step 2200 (which may be optional), the UE receives input data provided by the host computer. Additionally or alternatively, in step 2202, the UE provides user data. In sub-step 2204 (which may be optional) of step 2200, the UE provides the user data by executing a client application. In sub-step 2206 (which may be optional) of step 2202, the UE executes a client application which provides the user data in reaction to the received input data provided by the host computer. In providing the user data, the executed client application may further consider user input received from the user. Regardless of the specific manner in which the user data was provided, the UE initiates, in sub-step 2208 (which may be optional), transmission of the user data to the host computer. In step 2210 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 23 will be included in this section. In step 2300 (which may be optional), in accordance with the teachings of the embodiments described throughout this disclosure, the base station receives user data from the UE. In step 2302 (which may be optional), the base station initiates transmission of the received user data to the host computer. In step 2304 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Other Embodiments

Embodiment 1. A method, performed at a UE, for handling transmissions in a serving cell SMTC window, the method comprising receiving a configuration indicating a serving cell SMTC window, receiving a configuration for UE-initiated UL transmission, and suppressing UE-initiated UL transmissions during at least a portion of the serving cell SMTC window.

Embodiment 2. The method of embodiment 1 wherein the UE-initiated UL transmissions are suppressed during the entire duration of the serving cell SMTC window.

Embodiment 3. The method of embodiment 1 comprising receiving information indicating a pattern of SSBs to be transmitted by the gNB (called candidate SSBs), wherein the UE-initiated UL transmissions are suppressed from the start of the serving cell SMTC window until the last candidate SSB.

Embodiment 4. The method of embodiment 3 wherein the information indicating a pattern of SSBs to be transmitted by the gNB comprises an ssb-PositionslnBurst IE.

Embodiment 5. The method of embodiment 3 or 4 wherein the UE determines the last SSB transmission by the gNB based on detection of at least one transmitted SSB and the information indicating the pattern of candidate SSBs.

Embodiment 6. The method of embodiment 5 wherein the UE presumes that the detected transmitted SSB corresponds to the first SSB in the pattern of candidate SSBs.

Embodiment 7. The method of embodiment 6 wherein the UE presumes that the last SSB transmission by the gNB corresponds to the last SSB in the pattern of candidate SSBs.

Embodiment 8. The method of any of embodiments 3-7 wherein the suppression of transmissions in a slot occurs only in the symbols corresponding to the candidate SSB positions.

Embodiment 9. The method of any of embodiments 3-7 wherein the suppression of transmissions in a slot occurs only in the symbols corresponding to the candidate SSB positions and in the symbols corresponding to the transmission of system information associated with the candidate SSB positions.

Embodiment 10. The method of any of embodiments 3-9 wherein the suppression of transmissions occurs in all symbols of any slot which contains a candidate SSB position.

Embodiment 11. The method of any of embodiments 1-10 further comprising using rate matching mechanisms to rate match around reserved resources which may contains signals from other technologies.

Embodiment 12. The method of embodiment 11 wherein using the rate matching mechanisms comprises using rate matching patterns provided to the UE by the gNB.

Embodiment 13. A UE for handling transmissions in the serving cell SMTC window, the UE comprising one or more processors and memory comprising instructions that, when executed by the one or more processors, cause the UE to perform any of the steps of the above embodiments. Those skilled in the art will recognize improvements and modifications to the embodiments of the present disclosure. All such improvements and modifications are considered within the scope of the concepts disclosed herein.

1. A method, performed at a User Equipment, UE, for handling transmissions in a serving cell Discovery Burst Transmission, DBT, window, the method comprising:
receiving a configuration indicating a serving cell DBT window;
receiving a configuration for UE-initiated Uplink, UL, transmission;
suppressing UE-initiated UL transmissions during at least a portion of the serving cell DBT window; and
receiving information indicating a pattern of SSBs intended to be transmitted by a radio access node, and wherein suppressing the UE-initiated UL transmissions during the at least a portion of the serving cell DBT window comprises suppressing UE-initiated UL transmissions during symbols potentially occupied by the SSBs intended to be transmitted by the radio access node according to the pattern of SSBs.

2. The method of claim 1 wherein receiving the configuration indicating the serving cell DBT window comprises receiving an information element in either dedicated signaling or broadcast signaling containing a field that indicates a duration of the serving cell DBT window.

3. The method of claim 2 wherein the field in dedicated signaling is ServingCellConfigCommon and the field in broadcast signaling is ServingCellConfigCommonSIB.

4. The method of claim 2 wherein the field that indicates the duration of the serving cell DBT window comprises a discoveryBurstWindowLength-r16 field.

5. (canceled)

6. The method of claim 1 wherein receiving the information indicating the pattern of SSBs intended to be transmitted by the radio access node comprises receiving a bitmap that indicates the pattern.

7. The method of claim 6 wherein the bitmap is contained in the Information Element ssb-PositionsInBurst.

8. (canceled)

9. The method of claim 1 wherein suppressing the UE-initiated UL transmissions during the at least a portion of the serving cell DBT window comprises suppressing UE-initiated UL transmissions during all symbols of any slot containing symbols potentially occupied by the SSBs intended to be transmitted by the radio access node according to the pattern of SSBs.

10. The method of claim 1 wherein suppressing the UE-initiated UL transmissions during the at least a portion of the serving cell DBT window also comprises suppressing symbols corresponding to potential transmissions of system information.

11. (canceled)

12. The method of claim 1 wherein suppressing the UE-initiated UL transmissions during the at least a portion of the serving cell DBT window comprises suppressing UE-initiated UL transmissions during an entire duration of the serving cell DBT window.

13-21. (canceled)

22. A User Equipment, UE, for handling transmissions in a serving cell Discovery Burst Transmission, DBT, window, the UE comprising:
one or more processors; and
memory comprising instructions that, when executed by the one or more processors, cause the UE to:
receive a configuration indicating a serving cell DBT window;
receive a configuration for UE-initiated Uplink, UL, transmission;
suppress UE-initiated UL transmissions during at least a portion of the serving cell DBT window; and
receive information indicating a pattern of SSBs intended to be transmitted by a New Radio, NR, base station, radio access node, and wherein suppressing the UE-initiated UL transmissions during the at least a portion of the serving cell DBT window comprises suppressing UE-initiated UL transmissions during symbols potentially occupied by the SSBs intended to be transmitted by the radio access node according to the pattern of SSBs.

23. The UE of claim 22 wherein receiving the configuration indicating the serving cell DBT window comprises receiving an information element in either dedicated signaling or broadcast signaling containing a field that indicates a duration of the serving cell DBT window.

24. The UE of claim 23 wherein the field in dedicated signaling is ServingCellConfigCommon and the field in broadcast signaling is ServingCellConfigCommonSlB.

25. The UE of claim 24 wherein the field that indicates the duration of the serving cell DBT window comprises a discoveryBurstWindowLength-r16 field.

26. (canceled)

27. The UE of claim 22 wherein receiving the information indicating the pattern of SSBs intended to be transmitted by the radio access node comprises receiving a bitmap that indicates the pattern.

28. The UE of claim 27 wherein the bitmap is contained in the Information Element ssb-PositionsInBurst.

29. (canceled)

30. The UE of claim 22 wherein suppressing the UE-initiated UL transmissions during the at least a portion of the serving cell DBT window comprises suppressing UE-initiated UL transmissions during all symbols of any slot containing symbols potentially occupied by the SSBs intended to be transmitted by the radio access node according to the pattern of SSBs.

31. The UE of claim 22 wherein suppressing the UE-initiated UL transmissions during the at least a portion of the serving cell DBT window also comprises suppressing symbols corresponding to potential transmissions of system information.

32. (canceled)

33. The UE of claim 22 wherein suppressing the UE-initiated UL transmissions during the at least a portion of the serving cell DBT window comprises suppressing UE-initiated UL transmissions during an entire duration of the serving cell DBT window.

34-50. (canceled)

51. A method, performed at a radio access node, for handling transmissions in a serving cell Discovery Burst Transmission, DBT, window, the method comprising:
transmitting, to a User Equipment, UE, a configuration indicating a serving cell DBT window;
transmitting, to the UE, information indicating a pattern of SSBs intended to be transmitted by the radio access node during the serving cell DBT window; and
transmitting SSBs according to the pattern of SSBs intended to be transmitted by the radio access node during the serving cell DBT window.

52. The method of claim 51 wherein transmitting the configuration indicating the serving cell DBT window comprises transmitting a ServingCellConfigCommon Information Element, IE, or a ServingCellConfigCommonSlB IE containing a field that indicates a duration of the serving cell DBT window.

53. The method of claim 52 wherein the field that indicates the duration of the serving cell DBT window comprises a discoveryBurstWindowLength-r16 field.

54. The method of claim 51 wherein transmitting the information indicating the pattern of SSBs intended to be transmitted by the radio access node comprises transmitting an ssb-PositionsInBurst Information Element.

55. A radio access node, for handling transmissions in a serving cell Discovery Burst Transmission, DBT, window, the radio access node comprising:
one or more processors; and
memory comprising instructions that, when executed by the one or more processors, cause the radio access node to:
transmit, to a User Equipment, UE, a configuration indicating a serving cell DBT window;
transmit, to the UE, information indicating a pattern of SSBs intended to be transmitted by the radio access node during the serving cell DBT window; and
transmit SSBs according to the pattern of SSBs intended to be transmitted by the radio access node during the serving cell DBT window.

56. The radio access node of claim 55 wherein transmitting the configuration indicating the serving cell DBT window comprises transmitting a ServingCellConfigCommon Information Element, IE, or a ServingCellConfigCommonSlB IE containing a field that indicates a duration of the serving cell DBT window.

57. The radio access node of claim 56 wherein the field that indicates the duration of the serving cell DBT window comprises a discoveryBurstWindowLength-r16 field.

58. The radio access node of claim 55 wherein transmitting the information indicating the pattern of SSBs intended to be transmitted by the radio access node comprises transmitting an ssb-PositionsInBurst Information Element.

59-66. (canceled)
